(19) United States
(12) Patent Application Publication
(10) Pub. No.: US 2025/0091235 A1
(43) Pub. Date: Mar. 20, 2025

(54) SENSOR-BASED SYSTEMS AND METHODS OF ANALYZING SHAVING USAGE

(71) Applicant: The Gillette Company LLC, Boston, MA (US)

(72) Inventors: Ian Anthony Good, Reading (GB); Alexander James Hinchliffe Friend, Market Drayton (GB); Susan Clare Robinson, Windsor (GB); Nicola Dawn Dixon, Swindon (GB); Angela Louise Richardson, Henley on Thames (GB); Lindsey Claire McConnell, Reading (GB); Christopher Francis Rawlings, Reading (GB); Faiz Feisal Sherman, Mason, OH (US); Robert Thomas Hinkle, Sharonville, OH (US); Olaf Soerensen, Mainz (DE)

(21) Appl. No.: 18/468,262

(22) Filed: Sep. 15, 2023

(51) Int. Cl. B26B 21/40; B26B 21/22

(52) U.S. Cl. CPC B26B 21/4056; B26B 21/4087; B26B 21/222

(57) ABSTRACT

Sensor-based systems and methods of analyzing shaving usage based on time duration and shave event status. A shaving device comprises a blade. The shaving device is communicatively coupled to a sensor and one or more processor(s). Sensor data is collected from the sensor while a user is shaving, and user-specific pressure data is determined therefrom to define shaving stroke(s) based on pressure applied to the user's skin. Based on the one or more shaving strokes and timer intervals thereof, a total duration can be tracked. In addition, a shaving event can be determined based on the shaving stroke(s). An output associated with the shaving device may be generated based on the determining that each of a predetermined duration threshold value and a predetermined shave event threshold value has been met or exceeded, the output comprising an indication that the each of the thresholds has been met or exceeded.

### FIELD

The present disclosure generally relates to sensor-based systems and methods, and more particularly to, sensor-based systems and methods of analyzing shaving usage based on time duration and shave event status.

### BACKGROUND

Generally, shave performance can be summarized as a trade-off between closeness and irritation, where an individual typically can either achieve, on the one hand, an increased closeness of shave (removing more hair) but risking irritation or redness of his or her skin, or, on the other hand, a less close shave (leaving more hair) but reducing the risk of skin irritation. Individuals typically try to balance this trade-off to get their desired end result by manually regulating the quantity, direction and pressure (or load) of strokes applied during a shave. Taking an increased quantity of strokes, taking strokes going against the direction of hair growth or applying increased pressure during strokes will typically result in both increased closeness and increased risk of skin irritation. However, there is typically a point of shave pressure that once breached yields minimal increase closeness benefit while yielding a high risk of unwanted skin irritation.

Thus a problem arises for existing shaving razors, and the use thereof, where individuals desiring a close shave generally apply too many strokes, too many strokes going against the hair growth direction and/or too much pressure (or load) during a shave session, under the false impression that it will improve the closeness of the end result. The problem is acutely pronounced given the various versions, brands, and types of shaving razors currently available to individuals, where each of the versions, brands, and types of shaving razors have different components, blades, sharpness, and/or otherwise different configurations, all of which can vary significantly in the quantity, direction and pressure (or load) of strokes required, and for each shaving razor type, to achieve a close shave (e.g., with little or no hair remaining) with little or no skin irritation. This problem is particularly acute because such existing shaving razors—which may be differently configured—provide little or no feedback or guidance to assist the individual achieve a close shave without skin irritation.

For the foregoing reasons, there is a need for sensor-based systems and methods of analyzing shaving usage based on time duration and shave event status.

### SUMMARY

Sensor-based shaving systems and methods are described herein regarding analyzing shaving usage based on time duration and shave event status. Generally, the sensor-based shaving systems and methods comprise a shaving device (e.g., a shaving razor such as a wet shave razor). The shaving device can include a handle and a connecting structure for connecting a hair-cutting implement (e.g., a razor blade). The shaving device can also comprise, or be associated with, a shave event sensor (e.g., a load sensor) to collect shaving data of a user. Live feedback and/or indicators may be provided the user via an indication, e.g., green light-emitting diode (LED) feedback when the user is applying pressure within or below a unique threshold value, or a red LED feedback when the user is applying pressure above the unique threshold value of the user.

Reducing skin irritation may be determined by various factors, including, for example, the user's shave behavior and the wear on a cartridge (e.g., a razor blade). Other external factors may also be determinative, such as the presence of shave preparation and/or environmental conditions (e.g., wet or dry shaving). Such factors can be measured electronically by sensors associated with a shaving device and/or reported as data as supplied by the user, e.g., via a display screen. A user may monitor, track, or otherwise use the output and feedback (e.g., a user-specific shave strokes or sessions) to modify his or her behavior and seek to improve his or her user-specific shaving usage, resulting less real-world skin irritation, such then better shave experience or performance.

Indication and/or load feedback features, as provided by the sensor-based systems and methods, warn users to deter behavior that causes skin irritation, and encourages behavior that reduces skin irritation. For this reason, analysis of a load threshold of a user (e.g., a unique threshold value) to determine deviation from the threshold value during a shave stroke can allow the user to prevent skin damage. For example, a vast majority of user shave strokes typically lies within the range of 50 gram-force (gf) to 500 gf, and the average peak load during a shave stroke is approximately in the range of 200 gf to 250 gf. Based on this data, a load threshold value of a user (e.g., a unique threshold value), for example 250 gf, can be set or determined for a shaving device of the user, e.g., at least as an initial target value, to encourage a user to change his or her behavior to bring his or her specific load or pressure (as applied to his or her skin or face) to within a lower half of the typical load range, or at least within a deviation to reduce skin irritation. Reduction of load or pressure to a user's skin or face provides an irritation benefit, and at a specific user level using the unique threshold value, which may be specific to each user, as described herein.

Still further, the sharpness or otherwise efficacy of a razor, blade, or otherwise shaving implement may deteriorate overtime, which can also lead to skin irritation. In such aspects, analysis of a total duration of shaving strokes (e.g., each having time intervals) taken by a user with a given razor, blade, or otherwise shaving implement can be compared to a predetermined duration threshold value (e.g., a time-based threshold value) to determine deviation from an optimal threshold value defining a useful life of the razor, blade, or otherwise cleaning implement, which can be used to inform the user that it is time to replace the blade, thus allowing the user to prevent skin damage.

Generally, in various aspects, unique, specific, and/or personalized threshold values, as used, stored, and/or implemented by a shaving device as described herein, may be generated and/or used to provide corresponding specific users with unique, specific, and/or personalized shaving feedback and performance for the purpose of reducing skin irritation.

More specifically, in accordance with various embodiments herein, a sensor-based method of analyzing shaving usage based on time duration and shave event status is disclosed. The sensor-based method may include: defining, in a computer readable memory, each of a predetermined duration threshold value and a predetermined shave event threshold value; collecting, by one or more processors, sensor data from a sensor of a shaving device having a blade, the sensor data collected while a user is shaving; determining, based on the sensor data, user-specific pressure data defining one or more shaving strokes based on pressure applied to the user's skin; detecting, based on the one or more shaving strokes, that a shaving event occurred; incrementing, in the computer readable memory and based on detection of the shaving event, a shave event count value; determining that the shave event count value meets or exceeds the predetermined shave event threshold value; tracking, based on a timer, one or more intervals of time values for each of the one or more shaving strokes; calculating, based on the one or more interval of time values, a total duration of the one or more shaving strokes; determining that the total duration meets or exceeds the predetermined duration threshold value, and; generating an output associated with the shaving device based on (a) the determining that the total duration meets or exceeds the predetermined duration threshold value, and (b) the determining that the shave event count value meets or exceeds the predetermined shave event threshold value, the output including an indication that each of the predetermined duration threshold value and the predetermined shave event threshold value has been met or exceeded.

In additional embodiments, as described herein, a sensor-based shaving system configured to analyze shaving usage based on time duration and shave event status is disclosed. The sensor-based system may comprise: a shaving device including a blade; a sensor coupled to the shaving device and configured collect sensor data while a user is shaving with the shaving device; and a processor, configured onboard or offboard the shaving device, and communicatively coupled to the sensor, wherein the processor is configured to execute computing instructions stored on a computer readable memory communicatively coupled to the processor, the instructions, when executed, configured to cause the processor to: define, in a computer readable memory, each of a predetermined duration threshold value and a predetermined shave event threshold value; collect, by one or more processors, sensor data from a sensor of a shaving device having a blade, the sensor data collected while a user is shaving; determine, based on the sensor data, user-specific pressure data defining one or more shaving strokes based on pressure applied to the user's skin; detect, based on the one or more shaving strokes, that a shaving event occurred; increment, in the computer readable memory and based on detection of the shaving event, a shave event count value; determine that the shave event count value meets or exceeds the predetermined shave event threshold value; track, based on a timer, one or more intervals of time values for each of the one or more shaving strokes; calculate, based on the one or more interval of time values, a total duration of the one or more shaving strokes; determine that the total duration meets or exceeds the predetermined duration threshold value, and; generate an output associated with the shaving device based on (a) the determining that the total duration meets or exceeds the predetermined duration threshold value, and (b) the determining that the shave event count value meets or exceeds the predetermined shave event threshold value, the output including an indication that each of the predetermined duration threshold value and the predetermined shave event threshold value has been met or exceeded.

In still further embodiments, a non-transitory computer-readable medium storing computing instructions that when executed by one or more processors for analyzing shaving usage based on time duration is disclosed. The computing instructions, when executed by the one or more processors, may cause the one or more processors to: define, in a computer readable memory, each of a predetermined duration threshold value and a predetermined shave event threshold value; collect, by one or more processors, sensor data from a sensor of a shaving device having a blade, the sensor data collected while a user is shaving; determine, based on the sensor data, user-specific pressure data defining one or more shaving strokes based on pressure applied to the user's skin; detect, based on the one or more shaving strokes, that a shaving event occurred; increment, in the computer readable memory and based on detection of the shaving event, a shave event count value; determine that the shave event count value meets or exceeds the predetermined shave event threshold value; track, based on a timer, one or more intervals of time values for each of the one or more shaving strokes; calculate, based on the one or more interval of time values, a total duration of the one or more shaving strokes; determine that the total duration meets or exceeds the predetermined duration threshold value, and; generate an output associated with the shaving device based on (a) the determining that the total duration meets or exceeds the predetermined duration threshold value, and (b) the determining that the shave event count value meets or exceeds the predetermined shave event threshold value, the output including an indication that each of the predetermined duration threshold value and the predetermined shave event threshold value has been met or exceeded.

In addition, the present disclosure includes applying certain of the claim elements with, or by use of, a particular machine, e.g., a shaving device comprising a blade. The shaving device comprises at least one sensor coupled to the shaving device and configured collect sensor data while a user is shaving with the shaving device.

In addition, the present disclosure includes specific features other than what is well-understood, routine, conventional activity in the field, or adding unconventional steps that confine the claim to a particular useful application, e.g., sensor-based systems and methods of analyzing shaving usage based on time duration and shave event status as described herein.

Advantages will become more apparent to those of ordinary skill in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1A illustrates an example sensor-based shaving system configured to analyze shaving usage based on time duration and shave event status in accordance with various embodiments disclosed herein.

FIG. 1B illustrates an example shaving device in accordance with various embodiments disclosed herein.

FIG. 2 illustrates a further example of a sensor-based shaving system, having multiple shaving devices, and configured to analyze shaving usage based on time duration and shave event status for respective users in accordance with various embodiments disclosed herein.

FIG. 3 illustrates a flowchart or algorithm of an example sensor-based method of analyzing shaving usage based on time duration and shave event status in accordance with various embodiments disclosed herein.

FIG. 4 illustrates an example of a user shaving with the shaving device as described for FIGS. 1A, 1B, and 2 in accordance with various embodiments disclosed herein.

FIG. 5 illustrates an example user interface as rendered on a display screen of a user computing device in accordance with various embodiments disclosed herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

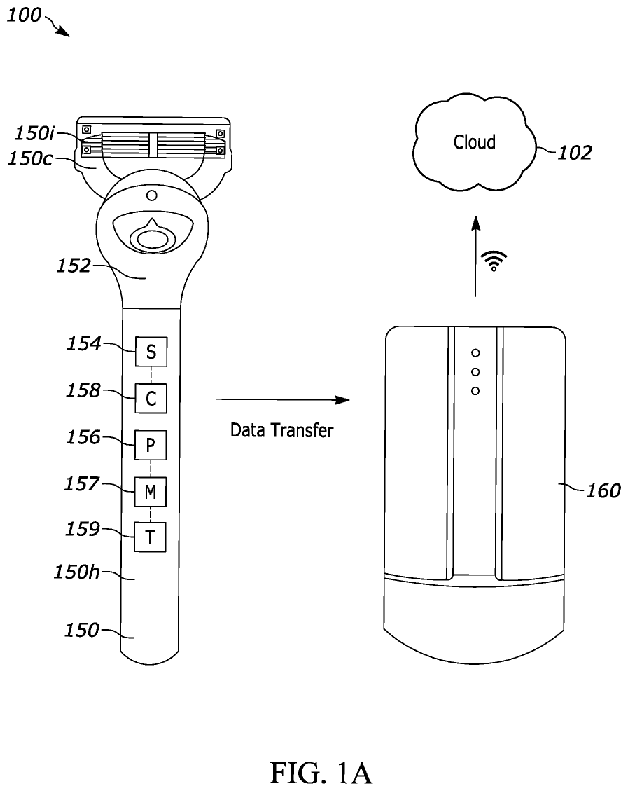

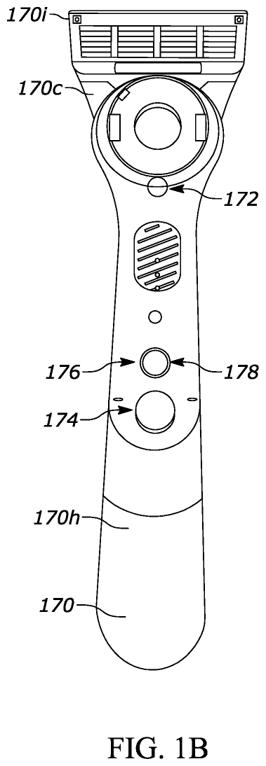

FIG. 1A illustrates an example sensor-based shaving system 100 configured to analyze shaving usage in accordance with various embodiments disclosed herein. As shown in the embodiment of FIG. 1A, sensor-based shaving system 100 comprises a shaving device 150 (e.g., a grooming device) having (i) a handle 150h comprising a connecting structure 150c, and (ii) a hair cutting implement 150i connected to the connecting structure 150c. In the embodiment of embodiment of FIG. 1A, shaving device 150 is illustrated as a shaving razor with a detachable hair-cutting implement 150i (e.g., a razor blade or cartridge). A shaving device, as described herein, may comprise other similar shaving devices, including, for example, but not limited to at least one of an electric shaver, a shaving razor, or an epilator.

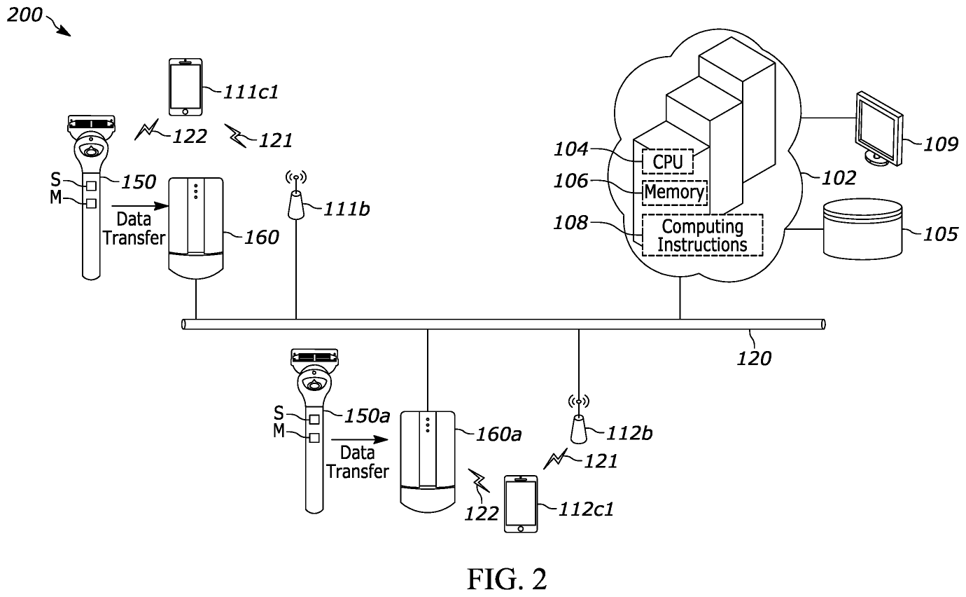

Sensor-based shaving system 100 further comprises a shave event sensor 154 (e.g., a load sensor) configured to collect sensor data. Shave event sensor 154 may comprise one or more of a displacement sensor, a load sensor, a movement sensor, an optical sensor, an audio sensor, and/or a temperature sensor. In the embodiment of FIG. 1A, shave event sensor 154 is communicatively coupled to shaving device 150, where shave event sensor 154 is positioned on shaving device 150. In other embodiments, shave event sensor 154 may be communicatively coupled, e.g., via wired or wireless communication, to a charging station (not shown) of a shaving device (e.g., shaving device 150), a cradle (not shown) for holding or receiving the shaving device (e.g., shaving device 150), or a computing device having a processor (e.g., user computing device 111c1 as illustrated in FIG. 2 herein) executing a digital app.

Sensor-based shaving system 100 further comprises a transceiver 158. In various embodiments, the transceiver 158 may be a wired or wireless transceiver positioned on or within shaving device 150. The transceiver 158 may comprise any one or more of a wired connection or a wireless connection, such as a Bluetooth connection, a Wi-Fi connection, a cellular connection and/or an infrared connection. In various embodiments, the transceiver 158 is communicatively coupled to the shaving device, a charging station (not shown) of the shaving device, cradle (not shown) for holding or receiving the shaving device (e.g., shaving device 150), or a computing device having a processor (e.g., user computing device 111c1 as illustrated in FIG. 2 herein) executing a digital application (app).

Sensor-based shaving system 100 further comprises a processor 156 (e.g., a microprocessor) and is communicatively coupled, e.g., via a computing bus or printed circuit board (PCB), to shave event sensor 154 and the transceiver 158. Processor 156 is configured to receive, transmit, and analyze data (e.g., shave data) as provided from shave event sensor 154 and/or the transceiver 158. In various embodiments, processor 156 is configured to execute computing instructions stored on a memory 157 (e.g., of shaving device 150) communicatively coupled to processor 156. The instructions may cause processor 156 to collect data from the shave event sensor. The data may comprise shave data defining a shave event and/or one or more time value(s), e.g., such as one or more shaving strokes of a user shaving with the shaving device. The sensor-based shaving system 100 may further comprise a timer 159 communicatively coupled to the processor and configured for calculating or tracking one or more intervals of time, e.g., when an interval of time corresponds to a specific event, such as a shaving stroke.

In the embodiment of FIG. 1A, processor 156 is illustrated as on-board shaving device 150. For example, in some embodiments, generation of an output associated with the shaving device, may be implemented by an onboard processor onboard the shaving device (e.g., shaving device 150).

Additionally, or alternatively, processor 156 may be located off board the shaving device. For example, processor 156 may be located on a cradle, charging station to which shaving device 150 connects. Still further, in some aspects, processor 156 may comprise a processor of a user computing device (e.g., user computing device 111c1). In additional aspects, the generation of the output, may be implemented by an off-board processor (e.g., a processor of server(s) 102 as described for FIG. 2 herein) communicatively coupled to the shaving device (e.g., shaving device 150) via a wired or wireless computer network. Still further, in some embodiments, the off-board processor may be configured to execute as part of one or more processors comprising at least one of a base station of the shaving device (e.g., shaving device 150), a mobile device (e.g., user computing device 111c1 as illustrated in FIG. 2 herein), or a remote computing device (e.g., server(s) 102, which may be cloud based servers a described herein). In such embodiments, shaving device 150 may transmit and/or receive, e.g., via its transceiver 158 and/or processor, sensor data, shave data and/or datasets to a computer network device 160, e.g., which may be a router, Wi-Fi router, hub, or switch, capable of sending and receiving data on a computer network, e.g., to server(s) 102 as described for FIG. 2 herein. In some aspects, computer network device 160 may be base or docking station that can receive the shaving device 150 for charging a battery of the shaving device 150 and/or transmitting data to computer network 120.

FIG. 1B illustrates an example shaving device 170 in accordance with various embodiments disclosed herein. Shaving device 170 represents a localized or device-only type shaving device (e.g., a shaving razor) that is not connected to a cloud or network. The shaving device 170 includes the same or similar components or otherwise aspects of shaving device 150 but is otherwise configured to operate as a standalone razor having its own processor, memory, sensor, timer, and software executing instructions thereof for performance of its various features (not shown). For example, shaving device 170 (e.g., a grooming device) comprises a handle 170h having a connecting structure 170c, and a hair cutting implement 170i connected to the connecting structure 170c. In the embodiment of embodiment of FIG. 1B (as for FIG. 1A), shaving device 170 is illustrated as a shaving razor with a detachable hair-cutting implement 170i (e.g., a razor blade or cartridge). Further, shaving device 170 comprises LED indicator 172, which is the same or similar as LED indicator 152 as described herein for shaving device 150. For example, LED indicator 172 may be used to indicate various degrees of pressure that is applied by the user during shaving or to indicate a duration of shaving. In some aspects, LED indicator 172 may change different colors based on the amount of pressure applied and/or total duration of time used for a given blade or otherwise cutting implement. For example, a green color may indicate a pressure range that is considered ideal, a yellow color may indicate a pressure range that is less than ideal (e.g., too much pressure), and a red color may indicate a pressure range that is far from idea (e.g., a great quantity of pressure). The pressure may be sensed by the pressure sensor(s) of shaving device 170 and received by a processor of the shaving device 170. The processor may then compare the pressure data to one or more range(s) and update the color the LED indicator 172 to correspond to the detected range(s).

Shaving device 170 also comprises a power button 174, which can be used to toggle on and off (e.g., a duty cycle) of the shaving device 170. Still further, shaving device 170 may include blade replacement indicator 176 and a blade replacement indicator button 178. Blade replacement indicator 176 may indicate (e.g., via a LED and/or vibration) a blade life of the detachable hair-cutting implement 170i (e.g., a razor blade or cartridge) or otherwise when it is time to replace the detachable hair-cutting implement 170i. For example, such determination may be based on shaving sessions, events, or duration experienced by the cutting implement 170i as described herein. For example, the memory of shaving device 170 may track the number of shaving strokes and/or total duration to determine a number of shaving sessions or events that the hair-cutting implement 170i (e.g., a razor blade or cartridge) has experienced. The replacement indicator 176 may indicate a first color (e.g., green) when the hair-cutting implement 170i (e.g., a razor blade or cartridge) is below or within a range of a threshold number of shaving sessions, events, or a duration (e.g., a total duration). Further, the replacement indicator 176 may indicate via a second color (e.g., yellow) when the hair-cutting implement 170i (e.g., a razor blade or cartridge) has experienced a first number of shaving sessions, events, or a duration (e.g., a total duration) above a given threshold. Still further, the replacement indicator 176 may indicate via a third color (e.g., red) when the hair-cutting implement 170i (e.g., a razor blade or cartridge) has experienced a second (and higher) number of shaving sessions, events, or a duration (e.g., a total duration) which may further indicate that the hair-cutting implement 170i (e.g., a razor blade or cartridge) has surpassed a further threshold or has otherwise reached the end of its useful life (e.g., blade life). In various aspects, the blade replacement indicator button 178 may be pressed to reset the state of tracking the number of shaving sessions, events, or duration where, for example, pressing the replacement indicator button 178 may set the state of the number of shaving events, sessions, or duration in the memory of shaving device 170 to a zero value.

FIG. 2 illustrates a further example of a sensor-based shaving system 200, having multiple shaving devices, and configured to analyze shaving usage for respective users in accordance with various embodiments disclosed herein. For example, in the embodiment of FIG. 2, sensor-based system 200 includes shaving device 150 as described for FIG. 1A. Sensor-based system 200 further includes a second shaving device 150a. Shaving device 150a is configured the same or similarly as described herein for FIG. 1A. For example, shaving device 150 is configured to communicatively coupled to a computer network device 160, e.g., which may be a router, Wi-Fi router, hub, or switch, cable of sending and receiving packet data on a computer network (e.g., computer network 120), e.g., to server(s) 102 as shown for FIG. 2.

In the example embodiment of FIG. 2, sensor-based system 200 includes server(s) 102, which may comprise one or more computer servers. In various embodiments, server(s) 102 comprise multiple servers, which may comprise multiple, redundant, or replicated servers as part of a server farm. In still further embodiments, server(s) 102 may be implemented as cloud-based servers, such as a cloud-based computing platform. For example, server(s) 102 may be any one or more cloud-based platform(s) such as MICROSOFT AZURE, AMAZON AWS, or the like. Server(s) 102 may include one or more processor(s) 104 as well as one or more computer memories 106.

Memorie(s) 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) 106 may store an operating system (OS) (e.g., Microsoft Windows, Linux, UNIX, etc.) capable of facilitating the functionalities, apps, methods, or other software as discussed herein. The memorie(s) 106 may also store a computing instructions configured to update or change settings associated with operation of a given shaving device (e.g., shaving device 150 and/or shaving device 150a). Additionally, or alternatively, computing instructions 108 may also be stored in database 105, which is accessible or otherwise communicatively coupled to server(s) 102. The memories 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosures herein. For example, at least some of the applications, software components, or APIs may be, include, otherwise be part of, computing instructions 108, where each may be configured to facilitate their various functionalities discussed herein. It should be appreciated that one or more other applications may be envisioned and that are executed by the processor(s) 104.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosures herein.

The processor(s) 104 may interface with the memory 106 via the computer bus to execute the operating system (OS). The processor(s) 104 may also interface with the memory 106 via the computer bus to create, read, update, delete, or otherwise access or interact with the data stored in the memories 106 and/or the database 105 (e.g., a relational database, such as Oracle, DB2, MySQL, or a NoSQL based database, such as MongoDB). The data stored in the memories 106 and/or the database 105 may include all or part of any of the data or information described herein, including, for example, sensor data, shave data, and/or or datasets (e.g., first or subsequent datasets regarding sensor and/or shave data) or other information of the user, user profile data including demographic, age, race, skin type, or the like, and/or previous shave data associated with one or more shaving devices or implements. For example, in some embodiments, user profile data may be obtained via a questionnaire or display form in a software app associated with the shaving device 150, e.g., shave event data as reported by the user via a user computer device 111c1.

In some aspects, data (e.g., such as sensor data or user data) may be collected from multiple shaving devices (e.g., shaving device 150 and shaving device 150a). Such data may be used to update, change, modify or otherwise configure computing instructions 108, which may be stored on memory 106 and/or downloaded to shaving device 150 for storage on memory 157 and/or execution by processor 156.

With reference to FIG. 2, server(s) 102 may further include a transceiver configured to communicate (e.g., send and receive) data via one or more external/network port(s) to one or more networks or local terminals, such as computer network 120 and/or terminal 109 (for rendering or visualizing) described herein. In some embodiments, server(s) 102 may include a client-server platform technology such as ASP.NET, Java J2EE, Ruby on Rails, Node.js, a web service or online API, responsive for receiving and responding to electronic requests. The server(s) 102 may implement the client-server platform technology that may interact, via the computer bus, with the memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

According to some embodiments, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Server(s) 102 may further include or implement an operator interface configured to present information to an administrator or operator and/or receive inputs from the administrator or operator. As shown in FIG. 2, an operator interface may provide a display screen (e.g., via terminal 109). Server(s) 102 may also provide I/O components (e.g., ports, capacitive or resistive touch sensitive input panels, keys, buttons, lights, LEDs), which may be directly accessible via or attached to server(s) 102 or may be indirectly accessible via or attached to terminal 109. According to some embodiments, an administrator or operator may access the server 102 via terminal 109 to review information, make changes, input training data, and/or perform other functions.

As described above herein, in some embodiments, server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the computing instructions 108), or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 2, server(s) 102 are communicatively connected, via computer network 120 to shaving device 150 and shaving device 150a. Each of shaving device 150 and shaving device 150a may connect to their computer network devices 160, 160a, respectively, as described herein, e.g., which may be a router, Wi-Fi router, hub, or switch, capable of sending and receiving packet data on a computer network (e.g., computer network 120), e.g., to server(s) 102. In particular, computer network devices 160 and 160a may comprise routers, wireless switches, or other such wireless connection points communicating with user computing devices (e.g., user computing device 111c1 and user computing device 112c1) via wireless communications 122 based on any one or more of various wireless standards, including by non-limiting example, IEEE 802.11a/b/c/g (WIFI), the BLUETOOTH standard, or the like.

Server(s) 102 are also communicatively connected, via computer network 120, to user computing devices, including user computing device 111c1 and user computing device 112c1, via base stations 111b and 112b. Base stations 111b and 112b may comprise cellular base stations, such as cell towers, communicating to user computing devices (e.g., user computing device 111c1 and user computing device 112c1), via wireless communications 121 based on any one or more of various mobile phone standards, including NMT, GSM, CDMA, UMMTS, LTE, 5G, or the like.

User computing devices, including user computing device 111c1 and user computing device 112c 1 may connect to shaving device 150 and shaving device 150a either directly or via computer network devices 160 and 160a. Additionally, or alternatively, shaving device 150 and shaving device 150a may connect to server(s) 102 over computer network 120 via either base stations 111b or 112b and/or computer network devices 160 and 160a.

User computing devices (e.g., user computing device 111c1 and user computing device 112c1) may comprise mobile devices and/or client devices for accessing and/or communications with server(s) 102. In various embodiments, user computing devices (e.g., user computing device 111c1 and user computing device 112c1) may comprise a cellular phone, a mobile phone, a tablet device, a personal data assistance (PDA), or the like, including, by non-limiting example, an APPLE iPhone or iPad device or a GOOGLE ANDROID based mobile phone or table. In addition, the user computing devices (e.g., user computing device 111c1 and user computing device 112c1) may implement or execute an operating system (OS) or mobile platform such as Apple's iOS and/or Google's Android operating system. Any of the user computing devices (e.g., user computing device 111c1 and user computing device 112c1) may comprise one or more processors and/or one or more memories for storing, implementing, or executing computing instructions or code, e.g., a mobile application, as described in various embodiments herein.

User computing devices (e.g., user computing device 111c1 and user computing device 112c1) may comprise a wireless transceiver to receive and transmit wireless communications 121 and/or 122 to and from base stations 111b and/or 112b. In this way, data (e.g., such as sensor and/or user data) may be transmitted via computer network 120 to server(s) 102 for generating output(s) based on one and/or more of the predetermined threshold values as describe herein.

In some aspects, a shaving device (e.g., shaving device 150) may be communicatively coupled to a user computing device having a display screen. The display screen may output or render various data as described herein, including, for example an indication indicating that a shave event count and/or duration value meets or exceeds one or more respective predetermined threshold values.

For example, user computing devices (e.g., user computing device 111c1 and user computing device 112c1) may include a display screen for displaying graphics, images, text, data, interfaces, graphic user interfaces (GUI), and/or such visualizations or information as described herein. For example, the display screen of a user computing device (e.g., user computing device 111c1) may display images, e.g., such as an output, to the user, via an application (app) executing on a user computing device (e.g., user computing device 111c1). The app may execute instructions, via a programming language, to receive the shave data and render it on a display screen of the user computing device. For example, an app may be implemented via one or more app programming languages including, for example, via SWIFT or Java for APPLE iOS and Google Android platforms, respectively. In various embodiments, a display or GUI indication may include one or more visualizations of data and/or indicator(s) based on the sensor data (e.g., load or pressure values), data output (e.g., either raw data or processed data), user data, and/or graphs of the data (e.g., either raw data or processed data). Such display(s), GUI(s), or otherwise visualization(s) may be rendered or implemented via the app configured to execute on a user computer device (e.g., user computing device 111c1 as described herein). In such embodiments, the app may be configured to receive and render the shave data on a display screen of the user computing device (e.g., user computing device 111c1).

In some embodiments, the displayed data may be provided by the transceiver 158, which then may be provided to an output component (e.g., a display or LED) of the shaving device 150, and may be customizable by the user. For example, in various embodiments, the transceiver 158 is configured to provide an indication directly to the user (e.g., via an LED indicator 152) or, additionally or alternatively, to a display of a device (e.g., a display of a user computing device 111c1 as illustrated in FIG. 2 herein). The user may customize which, if any, of these ways the indication is provided.

In some aspects, the predetermined threshold value may be stored in a memory (e.g., memory 157) communicatively coupled to the one or more processors. Additionally, or alternatively, the predetermined threshold value, and impact and indicators thereof, may be tracked by comparing the predetermined threshold values, and impact and indicators thereof, as generated for other users (e.g., a user of second shaving device 150a).

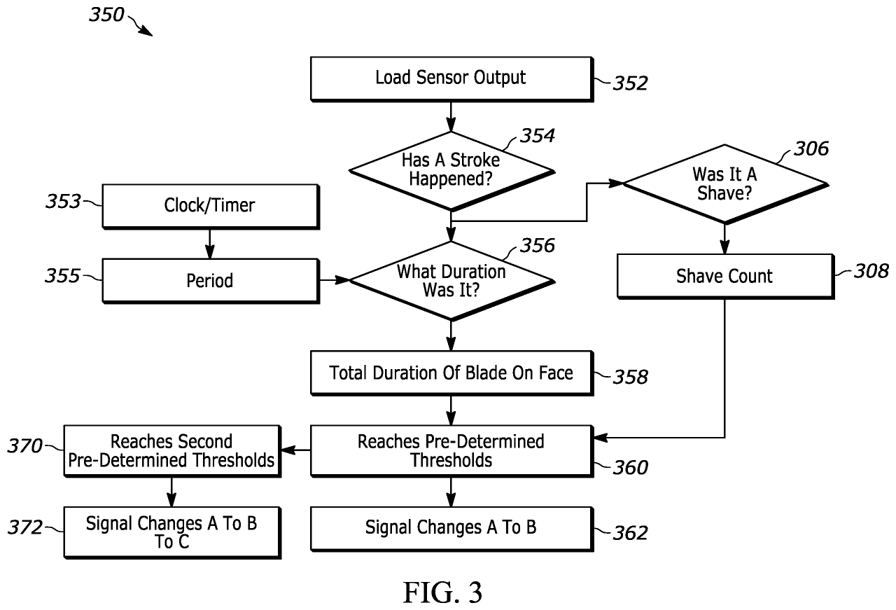

FIG. 3 illustrates a flowchart or algorithm of an example sensor-based method 350 of analyzing shaving usage based on time duration and shave event status in accordance with various embodiments disclosed herein. In the example embodiment of FIG. 3, a sensor (e.g., a load sensing sensor) provides a sensor-based shaving system or device (e.g., sensor-based shaving system 100, shaving device 150, and/or shaving device 170) with a signal for detecting or otherwise determining when a cutting implement (e.g., hair cutting implement 150i), such as a blade, is contacting a user's face. In some aspects, a shave event count may be determined and compared against a predetermined shave event threshold value. If predetermined shave event threshold value is met or exceeded, then a processor can generate signals and/or data indicating that the user should replace the cutting implement e.g., hair cutting implement 150i). Still further, in some aspects, a duration of face contact, for example, a total duration of a cutting implement (e.g., hair cutting implement 150i), such as a blade, contacting a user's face is computed (e.g., summed) to determine a time-of-use of the given cutting implement e.g., hair cutting implement 150i). If the total duration (e.g., time on face) or otherwise time-of-use exceeds one or more predetermined thresholds, then different signals or outputs can be triggered notifying the user of different stages of the cutting implement's overall usage, blade life, or otherwise estimate efficacy. For example, such signals (e.g., whether based on duration or shave event count) can indicate that the user should replace the cutting implement e.g., hair cutting implement 150i) to increase shave efficiency and/or decrease skin irritation. In various aspects, the total duration and/or shave event count value may be configured to be reset. For example, the total duration and/or shave event count value may be reset manually via a button to restart the time periods or time intervals and/or shave event count value recorded for a given shaving device (e.g., shaving device 150). Additionally, or alternatively, a total duration value and/or shave event count value may be reset by attaching a shaving implement (e.g., a new shaving implement or blade on the shaving device), powering the shaving device down, activating a setting from a display screen of an app as implemented on user computing device 111c1, and/or by returning the shaving device to a base, cradle, etc. (e.g., such as computer network device 160). In any event, in some aspects, the user can reset the total duration and/or shave event count value with an input. The input may comprise one or more of pressing a manual button of the shaving device (e.g., shaving device 150 and/or shaving device 170), inserting or adding a blade (e.g., such as a hair cutting implement 150i), powering down the shaving device (e.g., shaving device 150 and/or shaving device 170), or placing or otherwise connecting the shaving device to a base (e.g., such as computer network device 160).

With reference to FIG. 3, at block 352 method 350 comprises receiving sensor output (e.g., load sensor output) from a sensor of a shaving device (e.g., shaving device 150 or shaving device 170). The sensor output may be compared to predetermined threshold values (e.g., a predetermined duration threshold value and a predetermined shave event threshold value) as described herein. For example, each of the predetermined threshold values may be defined, in a computer readable memory. In various aspects, the computer readable medium comprises an onboard memory (e.g., memory 157) stored on the shaving device (e.g., shaving device 150 or shaving device 170). Each of the predetermined threshold values may stored in the onboard memory. Additionally, or alternatively, each of the predetermined threshold values may be stored remotely (e.g., on memory 106). Each of the predetermined threshold values may comprise a value defining a total duration of time before a blade should be replaced.

In some aspects, each of the predetermined threshold values (e.g., a predetermined duration threshold value and a predetermined shave event threshold value) may be set or otherwise configured during manufacture of the shaving device (e.g., shaving device 150 or shaving device 170). In still further aspects, each of the predetermined threshold values is adaptable or otherwise modifiable. For example, each of the predetermined threshold values can be adapted or modified to have a lower value (e.g., a lower total duration of time for the predetermined duration threshold value and a lower shave event count value for the predetermined shave event threshold value) for a user with more sensitive skin user and a higher value (e.g., a higher total duration of time for the predetermined duration threshold value and a higher shave event count value for the predetermined shave event threshold value) for a user with less sensitive skin. Still further, each of the predetermined threshold values may be modifiable by the user based on a universal threshold value (e.g., a factory or default setting), a user selected threshold value (e.g., a high, medium, or low mode), and/or a unique threshold value for the user (e.g., as determined by via diagnostic shave of the user, which may determine a baseline threshold value specific to the user).

In another example, the user may choose from a variety of predetermined settings or options (e.g., a “sensitive skin” option, a “regular” option, or the like). Such embodiments allow the user to adjust each of the unique threshold values by adjusting different threshold percentage values or by setting different modes.

Additionally, or alternative, a predetermined threshold value may be set by the one or more processors based on the sensor data. For example, one or more of the predetermined threshold values may be defined based on the usage of the shaving device, e.g., more usage of the shaving device may lower a given predetermined threshold value and vice versa. For example, computing instructions 108 may be used to set a unique threshold value (e.g., a predetermined duration threshold value and a predetermined shave event threshold value) for a user having similar skin to other users as reported to server(s) (e.g., server(s) 102). In such embodiments, a user may select one or more modes (e.g. high mode, medium mode, and/or low mode) to adjust their threshold based on data from other users. The selection may be made, e.g., via a software application (app) executing on a user computing device (e.g., as shown and described for FIGS. 1A, 1B, and/or 5 herein).

With further reference to FIG. 3, at block 354 method 350 comprises a determination whether a stroke has happened. This may comprise collecting, by one or more processors (e.g., processor 156 and/or processor(s) 104), sensor data from a sensor of a shaving device having a blade (e.g., cutting implement 150i). The sensor data is collected while a user is shaving. The one or more processors may be processors of the shaving device itself and/or those of a server in communication with a processor of the shaving device (e.g., shaving device 150 or shaving device 170).

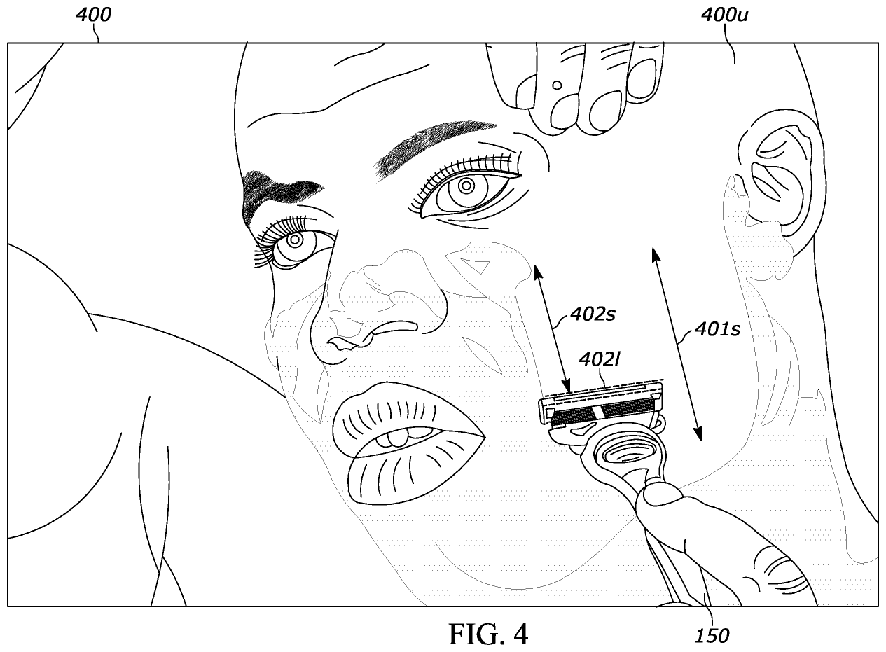

Method 350 may further comprise determining, based on the sensor data, user-specific pressure data defining one or more shaving strokes based on pressure applied to the user's skin. For example, FIG. 4 illustrates an example user (e.g., user 400u) shaving with the shaving device (e.g., shaving device 150 or shaving device 170) as described for FIGS. 1A, 1B, and 2 in accordance with various embodiments disclosed herein. In the example of FIG. 4, user 400u has made two shaving strokes (i.e., shaving stroke 401s and shaving stroke 402s) with shaving device 150 or 170. Sensor data is collected by sensor 154 as user 400u moves the razor across his skin. The sensor data may include location data, direction data, and/or pressure or load data, including for example, pressure or load data (e.g., load data 4021) at the point where the razor or otherwise cutting implement is applied the user's (e.g., user 400u) skin. The sensor data may be analyzed to determine the direction, path, and/or count of the users shaving strokes (e.g., shaving stroke 401s and shaving stroke 402s) for a given shaving session (e.g., a time period between the start and end of a shaving session and/or otherwise the shaving of the face, legs, or other area of the body).

With further reference to FIG. 3, at block 306 method 350 further comprises detecting, based on the one or more shaving strokes (e.g., shaving stroke 401s and shaving stroke 402s), that a shaving event occurred. The shave event may comprise, for example, the detection of a shave (e.g., a certain number of strokes, such as 20 to 30 strokes) indicating that a shaving session (e.g., shaving of the face, legs, or other area of the body) has been completed.

At block 308 method 350 further comprises incrementing, in the computer memory (e.g., memory 106 and/or 157) and based on detection of the shaving event, a shave event count value. The shave event count value may define a total number of shaving events or shaving sessions that have currently occurred for a given shaving device. In various aspects, the shave event count value may be configured to be reset. For example, the shave count event may be reset manually via a button to restart the number of shaving events or sessions recorded for a given shaving device (e.g., shaving device 150). Additionally, or alternatively, a shave event count may be reset by attaching a shaving implement (e.g., a new shaving implement or blade on the shaving device), powering the shaving device down, activating a setting from a display screen of an app as implemented on user computing device 111c1, and/or by returning the shaving device to a base, cradle, etc. (e.g., such as computer network device 160). For example, in some aspects, the user can reset the shave event count with an input. The input may comprise one or more of pressing a manual button of the shaving device (e.g., shaving device 150 and/or shaving device 170), inserting or adding a blade (e.g., such as a hair cutting implement 150i), powering down the shaving device (e.g., shaving device 150 and/or shaving device 170), or placing or otherwise connecting the shaving device to a base (e.g., such as computer network device 160).

With further reference to FIG. 3, at block 356 method 350 comprises determining a duration of a given stroke. This can comprise, for example, tracking, based on a timer (e.g., timer 159), one or more intervals of time values for each of the one or more shaving strokes. The tracking may be performed by one or more processors (e.g., processor 156 and/or processor(s) 104). The one or more processors may be communicatively coupled to a timer (e.g., timer 159), where at block 353 the timer is referenced or accessed by the one or more processors to determine, at block 355, one or more period(s) of time, which may comprise interval of time value(s) during which a user was shaving with a shaving device (e.g., shaving device 150 or shaving device 170). Each period of time and corresponding interval of time value may correspond to a shaving stroke of the user, for example, as described and depicted for FIG. 4 and/or elsewhere herein. The shaving stroke may be defined by the sensor data indicative of a given stroke. For example, the sensor data may define a stroke in a given direction for a period of time. Additionally, or alternatively, a shaving stroke may be detected as a load event where the load sensor data exceeds a certain pressure threshold. For example, in some aspects, pressure as determined by sensor data of a sensor (e.g., sensor 159) can cause the processor one or more processors (e.g., processor 156 and/or processor(s) 104) to actuate the timer (e.g., timer 159) on-and-off. The timer can begin counting (e.g., in seconds) when started and can report a time value (e.g., in seconds) when the timer is deactivated. For example, the timer can start when the load exceeds a given amount and can stop when the pressure reading goes below the amount. In this way, a duration (or otherwise period or interval of time value) of a stroke can be determined. Additionally, or alternatively, the timer may report a continuous value (e.g., a clock value comprising a 12-hour or 24-hour value, e.g., 1:39 PM or 13:39). In such aspects, the timer can report to the processor(s) a start time and an end time corresponding to when the timer was accessed or queried for the given time. A corresponding interval of time value can then be determined therefrom, where a value (e.g., in seconds) can be determined as a difference between start and end clock values for the shaving stroke in the given period. In this way, a duration (or otherwise period or interval of time value) of a stroke can be determined.

At block 358 method 350 comprises calculating a total duration of a cutting implement (e.g., a blade) on the face of the user. This may include, for example, calculating, based on the one or more interval of time values (e.g., as determined during block 356), a total duration of the one or more shaving strokes. For example, such intervals of time values (e.g., periods) may be summed into a total duration of time for a given set of shaving strokes in a given shaving session. Table 1 below shows non-limiting examples of total durations of example shaving sessions. Each session may be summed from one or more periods of time (e.g., intervals of time value(s)), which may correspond to one or more shaving strokes as described above, for example, with respect to method 350, and/or as described and depicted for FIG. 4, and/or elsewhere herein.

TABLE 1

| Shaving Session | Total Duration of Shaving Session | |
|---|---|---|
| Minimum Average | 23.5 | seconds |
| Overall Average | 71.8 | seconds |
| Maximum Average | 139.2 | seconds |

In the above Table 1 shave sessions with 30 strokes or more were analyzed. However, it is to be understood that greater or fewer strokes may also be used, and that may cause the total duration of shaving sessions to differ or vary. Still further, in the example of Table, 1 the respective total duration of shaving session values represents average values of multiple shave sessions, where shaving sessions were ranked for each consumer into minimum and maximum shaving sessions based on total time based on total duration, and then averaged (e.g., Minimum Average and Maximum Average, respectively). The Overall Average was then calculated by averaging each consumer's average, giving an average total duration across all users for a 30-strokes-or-more time period.

Table 2 below shows example total durations (e.g., total durations of time on a user's face) in seconds for a given number of shave sessions. Table 2 includes three rows illustrating different types of use cases (e.g., low, average, and maximum) per shaving session. Still further, the total duration values may be continuous values (and not discrete values) as illustrated in the example below for Table 2. It is to be understood, however, that Table 2 is non-limiting such that the values therein are merely exemplary.

TABLE 2

| | 5 shave | 10 shave | 12 shave | 14 shave | 18 shave | 20 shave | 30 shave |
|---|---|---|---|---|---|---|---|
| | sessions | sessions | sessions | sessions | sessions | sessions | sessions |
| Low use | 120 | 235 | 280 | 330 | 425 | 470 | 705 |
| per shave | | | | | | | |
| sessions | | | | | | | |
| (seconds) | | | | | | | |
| Average | 360 | 720 | 860 | 1005 | 1290 | 1435 | 2155 |
| use per | | | | | | | |
| shave | | | | | | | |
| sessions | | | | | | | |
| (seconds) | | | | | | | |
| Max use | 670 | 1400 | 1670 | 1950 | 2505 | 2785 | 4175 |
| per shave | | | | | | | |
| sessions | | | | | | | |
| (seconds) | | | | | | | |

In Table 2 above, the top row depicts low use per save sessions across different numbers of shaves (e.g., 5-30 shaving sessions representing, on a low usage basis, 120 seconds to 705 seconds, respectively). For example, as shown the top row of Table 2, low usage and high frequency changers (users) change their cutting implements after 120 seconds of usage time. As a further example, the middle row depicts example average use per save sessions across different numbers of shaves (e.g., 5-30 shaving sessions representing, on average, 360 seconds to 2155 seconds, respectively). As a still further example, the third row depicts example average use per save sessions across different numbers of shaves (e.g., 5-30 shaving sessions representing, on average, 670 seconds to 4175 seconds, respectively). For example, as shown the bottom row of Table 2, high usage and low frequency changers (users) change their cutting implements after 4175 seconds of usage time.

With further reference to FIG. 3, at block 360 method 350 comprises determining whether the total duration reaches a predetermined threshold. This may comprise, for example, determining that the total duration meets or exceeds the predetermined duration threshold value. For example, the predetermined duration threshold value may comprise a value in seconds, such as any of the values in Tables 1 or 2 as described above herein. It is to be understood, however, that additional and/or alternative values (not identified in Tables 1 or 2) may be utilized.

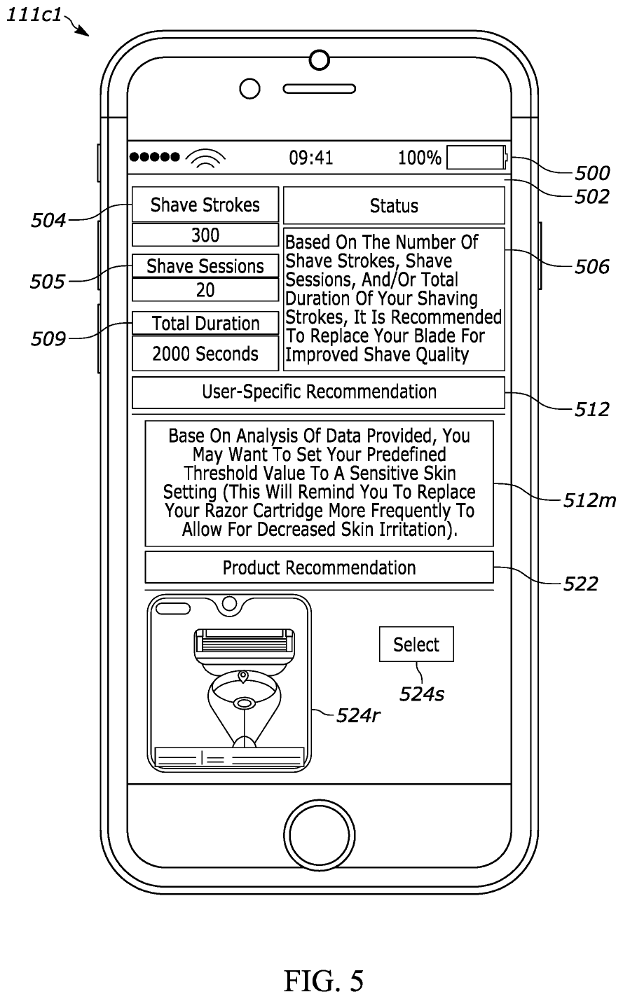

Block 360 of method 350 may further comprise determining that the shave event count value meets or exceeds the predetermined shave event threshold value. For example, in some aspects, this may comprise determine whether a shave event count value meets or exceeds a predetermined shave event threshold value of 20 or less, 14 or less, or, in some, cases a range, e.g., for example between 12 to 20 shave events or otherwise shave sessions (e.g., as shown for FIG. 5 herein).

With further reference to FIG. 3, at block 362 method 350 comprises generating an output (e.g., an output by one or more processor(s) (such as processor 156 and/or processor(s) 104) associated with the shaving device, based on (a) the determining that the total duration meets or exceeds the predetermined duration threshold value, and (b) the determining that the shave event count value meets or exceeds the predetermined shave event threshold value. The output may indicate a change from state “A” to “B,” indicating that replacement of the blade (e.g., cutting implement 150i) is warranted. The output comprising an indication that each of the predetermined duration threshold value and the predetermined shave event threshold value has been met or exceeded. For example, the indication may comprise at least one of: (a) a visual indicator (e.g., light such as numbers, words, icons, gauges, LEDs); (b) an audible indicator (e.g., a chime or other noise); (c) a vibration indicator (e.g., as generated by a vibrator in the handle of the shaving device); (d) a mechanical indicator (e.g., the shaving device powers off, e.g., the device powers off due to cartridge heat caused by friction, and/or the blade ejects or pivots); and/or (e) a message transmission indicator (e.g., transceiver 158 sends a message to a computing device 111c1 indicating that it is time to change the blade (e.g., cutting implement 150i). More generally, the output may comprise one or more visual indicia, such as, for example, one or more light emitting diodes (LEDs) on the shaving device (e.g., shaving device 150). Other outputs may comprise activation of a component of the shaving device at particular times. For example, one or more of a motor, a visual indicator (e.g., LED), a tactile indicator, and/or an audible indicator of the shaving device may be activated when a threshold value has been reached and/or exceeded. Additionally, or alternatively, other outputs by the one or more processor(s) (e.g., processor 156 and/or processor(s) 104) may also comprise shutting off the shaving device (e.g., including turning off, or varying the power supplied to, the cutting implement 150i), changing cartridge-heat of the cutting implement 150i, pivoting the cutting implement 150i, ejecting the cutting implement 150i.

With further reference to FIG. 3, at block 370 method 350 comprises defining, in a computer readable memory (e.g., memory 106 and/or 157), a second set of predetermined threshold values. In such aspects, the memory would have multiple (e.g., at least four) predetermined threshold values, which may comprise a second predetermined duration threshold value and a second predetermined shave event threshold value. At block 320, a processor (e.g., processor 104 and/or 156) may determine that the shave event count value meets or exceeds each of the multiple predetermined threshold values. For example, this may comprise determining that the total duration meets or exceeds the second predetermined duration threshold value, and further determining that the shave event count meets or exceeds the second predetermined shave event threshold value.

At block 372 method 350 comprises generating a second output associated with the shaving device. The output may indicate a change from state “B” to “C,” indicating that replacement of the blade (e.g., cutting implement 150i) is further warranted. The second output may comprise a second indication (e.g., same or different from the first indication) that each of the second predetermined duration threshold value and the second predetermined shave event threshold value has been met or exceeded.

It is to be understood, however, that additional predetermined threshold values, e.g., four or more predetermined threshold values are also contemplated herein, where such multiple predetermined threshold values are utilized in a stepped-based implementation or algorithm. In such stepped-based implementations or otherwise algorithms, each predetermined threshold value can be analyzed or otherwise tracked by the one or more processor(s) (such as processor 156 and/or processor(s) 104) and an output (e.g., any output as provided herein) can be triggered or provided when any one of the multiple predetermined threshold values are met or exceeded.

In some aspects, an output or indication may be detected by one or more processors (such as processor 156 and/or processor(s) 104) where the output may prevent feedback to the user. In such aspects, even though an output may comprise or otherwise trigger an indication, such output or indication may be prevented, oppressed, or otherwise silenced by the processor(s) before feedback reaches a user. For example, in such aspects the output or indication may be detected by one or more processor(s) and then intercepted or otherwise prevented from reaching the user, and thus, suppress feedback to the user. In such aspects, for example, a processor could intercept or otherwise prevent a visual, audio, tactile, mechanical, or other feedback type from being provided to the user. In some aspects, such functionality may be implemented by a silencing setting on, or otherwise turning off or preventing an output associated with, the shaving device. For example, in some aspects, the user may toggle on or off the silencing setting, which could be stored in memory (e.g., memory 157). A change in the setting (e.g., where silencing was indicated) would then cause a processor to prevent feedback (e.g., one or more of visual, audible, tactical, or otherwise) from being displayed, emitted, or otherwise provided to the user.

In additional aspects, based on the indication, a replacement blade may be initiated for shipment to the user, e.g., based on output the first output, second output, further output, or otherwise indication.

FIG. 5 illustrates an example graphic user interface (GUI) 502 as rendered on a display screen 500 of a user computing device (e.g., user computing device 111c1) in accordance with various embodiments disclosed herein. For example, as shown in the example of FIG. 5, user interface 502 may be implemented or rendered via an application (app) executing on user computing device 111c1. As shown in the example of FIG. 5, user interface 502 may be implemented or rendered via a native app executing on user computing device 111c1. In the example of FIG. 5, user computing device 111c1 is a user computer device as described for FIG. 2, e.g., where user computing device 111c1 is illustrated as an APPLE iPhone that implements the APPLE iOS operating system and has display screen 500. User computing device 111c1 may execute one or more native applications (apps) on its operating system. Such native apps may be implemented or coded (e.g., as computing instructions) in a computing language (e.g., SWIFT) executable by the user computing device operating system (e.g., APPLE iOS) by the processor of user computing device 111c1.

Additionally, or alternatively, user interface 502 may be implemented or rendered via a web interface, such as via a web browser application, e.g., Safari and/or Google Chrome app(s), or other such web browser or the like.

As shown in the example of FIG. 5, user interface 502 comprises an output, as generated by the algorithm or otherwise programming instructions described for method 350, of a number of shave strokes 504 and as rendered via GUI 502 on a display screen 500. The number of shave strokes 504 shows a value of “300” which may be a value for user 400u, reflecting that shaving device has counted, measured, and/or otherwise stored 300 shave strokes for a user for a given blade (e.g., data as collected from shaving device 150a, where user 400u uses shaving device 150). In addition, the number of shave sessions 505 corresponding to the number of shave strokes 504 may also be displayed. For example, as shown for FIG. 5, 20 shave sessions have occurred illustrating an example where 15 shave strokes per session (on average) were determined for the user, e.g., based on the user's settings. Still further, a total duration 509 for a given number of shave sessions corresponding to the number of shave strokes 504 may also be displayed. For example, as shown for FIG. 5, a total duration of 2000 seconds have occurred across 300 shave strokes as taken by the user, e.g., based on the user's settings. In various aspects, GUI 502 may provide a corresponding user-specific electronic recommendation 512 based on the number of shave strokes 504 and/or total duration 509 having a message 512m informing the user to choose or update his or her settings.

In some aspects, GUI 502 may comprise status information. For example, status information 506 may comprise an output, as generated by the algorithm or otherwise programming instructions described for method 350, with an indication or output regarding the number of shave strokes 504, shave sessions 505, and/or total duration 509. For example, one output, as generated by the algorithm or otherwise programming instructions described for method 350, could inform the user that the user should replace his or her blade (e.g., cutting implement 150i) based on the number of shave strokes 504 and/or total duration 509.

In some aspects, the user-specific electronic recommendation may comprise a product recommendation for a manufactured product based on the number of shave strokes 504, shave sessions 505, total duration 509, and/or user-specific electronic recommendation 512. For example, GUI 502 may render a product recommendation 522 indicating that the user should purchase product 524r to satisfy the user-specific electronic recommendation 512. The user may select 524s to order or otherwise receive the product from the GUI.

In some aspects, an output, as generated by the algorithm or otherwise programming instructions described for method 350, may comprise initiating, based on an indication, output, or otherwise the number of shave strokes 504, shave sessions 505, and/or total duration 509, a replacement blade for shipment to the user.

Additionally, or alternatively, an output, as generated by the algorithm or otherwise programming instructions described for method 350, may comprise an electronic communication transmitted to a computing device (e.g., user computing device 111c1) providing information of a shipment of a new blade (e.g., product 524r) to the user (e.g., 400u). The indication may be transmitted to servers 102 of a manufacturer or otherwise provider of the product in order to initiate the shipment.

In various embodiments, the number of shave strokes 504, total duration 509, user-specific electronic recommendation 512, message 512m, status information 506, and/or product recommendation 522 may be transmitted via the computer network, from server(s) 102, to the user computing device of the user for rendering on the display screen of the user computing device. In such aspects, server(s) 102 may have received sensor data, shave session data, shave stroke data, duration data, user data, and/or other data to generate or determine the various recommendations, which may then be transmitted, via computer network 120, to shaving device 150 and/or user computing device 111c1.

In other embodiments, no transmission to the server(s) 102 occurs, where the number of shave strokes 504, shave sessions 505, total duration 509, user-specific electronic recommendation 512, message 512m, status information 506, and/or product recommendation 522 may instead be generated locally, by the computing instructions executing and/or implemented on the shaving device 150 and/or the user's mobile device (e.g., user computing device 111c1) and rendered, by a processor of the mobile device, on a display screen of the mobile device (e.g., user computing device 111c1), or otherwise output or provided as described herein.

### ADDITIONAL CONSIDERATIONS

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensor-based method of analyzing shaving usage based on time duration and shave event status, the sensor-based method comprising:
defining, in a computer readable memory, each of a predetermined duration threshold value and a predetermined shave event threshold value;
collecting, by one or more processors, sensor data from a sensor of a shaving device having a blade, the sensor data collected while a user is shaving;
determining, based on the sensor data, user-specific pressure data defining one or more shaving strokes based on pressure applied to the user's skin;
detecting, based on the one or more shaving strokes, that a shaving event occurred;
incrementing, in the computer readable memory and based on detection of the shaving event, a shave event count value;
determining that the shave event count value meets or exceeds the predetermined shave event threshold value;
tracking, based on a timer, one or more intervals of time values for each of the one or more shaving strokes;
calculating, based on the one or more interval of time values, a total duration of the one or more shaving strokes;
determining that the total duration meets or exceeds the predetermined duration threshold value, and;
generating an output associated with the shaving device based on (a) the determining that the total duration meets or exceeds the predetermined duration threshold value, and (b) the determining that the shave event count value meets or exceeds the predetermined shave event threshold value, the output comprising an indication that each of the predetermined duration threshold value and the predetermined shave event threshold value has been met or exceeded.

2. The sensor-based method of claim 1 further comprising:
defining, in the computer readable memory, a second predetermined duration threshold value and a second predetermined shave event threshold value;
determining that the total duration meets or exceeds the second predetermined duration threshold value;
determining that the shave event count meets or exceeds the second predetermined shave event threshold value; and
generating a second output associated with the shaving device, the second output comprising a second indication that each of the second predetermined duration threshold value and the second predetermined shave event threshold value has been met or exceeded.

3. The sensor-based method of claim 1, wherein at least one of the total duration or the shave event count value is configured to be reset.

4. The sensor-based method of claim 1, wherein at least one of the predetermined duration threshold value or the predetermined shave event threshold value is adaptable.

5. The sensor-based method of claim 1, wherein at least one of the predetermined duration threshold value or the predetermined shave event threshold value is at least one of: (a) set during manufacture of the shaving device; (b); modifiable by the user; or (c) set by the one or more processors based on the sensor data.

6. The sensor-based method of claim 1 further comprising initiating, based on the indication, a replacement blade for shipment to the user.

7. The sensor-based method of claim 1, wherein the indication comprises at least one of: (a) a visual indicator; (b) an audible indicator; (c) a vibration indicator; (d) a mechanical indicator; or (e) a message transmission indicator.

8. The sensor-based method of claim 1, wherein the output comprising the indication is detected by the one or more processors, and wherein the one or more processors prevent feedback to the user.

9. The sensor-based method of claim 1, wherein the computer readable medium comprises an onboard memory stored on the shaving device, and wherein each of the predetermined duration threshold value and the predetermined shave event threshold value is stored in the onboard memory.

10. A sensor-based shaving system configured to analyze shaving usage based on time duration and shave event status, the system comprising:
a shaving device comprising a blade;
a sensor coupled to the shaving device and configured collect sensor data while a user is shaving with the shaving device; and
a processor, configured onboard or offboard the shaving device, and communicatively coupled to the sensor,
wherein the processor is configured to execute computing instructions stored on a computer readable memory communicatively coupled to the processor, the instructions, when executed, configured to cause the processor to:
define, in a computer readable memory, each of a predetermined duration threshold value and a predetermined shave event threshold value;
collect, by one or more processors, sensor data from a sensor of a shaving device having a blade, the sensor data collected while a user is shaving;
determine, based on the sensor data, user-specific pressure data defining one or more shaving strokes based on pressure applied to the user's skin;
detect, based on the one or more shaving strokes, that a shaving event occurred;
increment, in the computer readable memory and based on detection of the shaving event, a shave event count value;
determine that the shave event count value meets or exceeds the predetermined shave event threshold value;
track, based on a timer, one or more intervals of time values for each of the one or more shaving strokes;
calculate, based on the one or more interval of time values, a total duration of the one or more shaving strokes;
determine that the total duration meets or exceeds the predetermined duration threshold value, and;
generate an output associated with the shaving device based on (a) the determining that the total duration meets or exceeds the predetermined duration threshold value, and (b) the determining that the shave event count value meets or exceeds the predetermined shave event threshold value, the output comprising an indication that each of the predetermined duration threshold value and the predetermined shave event threshold value has been met or exceeded.

11. The sensor-based system of claim 10, wherein the computing instructions are further configured, when executed by the processor, to:
define, in the computer readable memory, a second predetermined duration threshold value and a second predetermined shave event threshold value;
determine that the total duration meets or exceeds the second predetermined duration threshold value;
determine that the shave event count meets or exceeds the second predetermined shave event threshold value; and
generate a second output associated with the shaving device, the second output comprising a second indication that each of the second predetermined duration threshold value and the second predetermined shave event threshold value has been met or exceeded.

12. The sensor-based system of claim 10, wherein at least one of the total duration or the shave event count value is configured to be reset.

13. The sensor-based system of claim 10, wherein at least one of the predetermined duration threshold value or the predetermined shave event threshold value is adaptable.

14. The sensor-based system of claim 10, wherein at least one of the predetermined duration threshold value or the predetermined shave event threshold value is at least one of: (a) set during manufacture of the shaving device; (b); modifiable by the user; or (c) set by the one or more processors based on the sensor data.

15. The sensor-based system of claim 10, wherein the computing instructions are further configured, when executed by the processor, to, based on the indication, a replacement blade for shipment to the user.

16. The sensor-based system of claim 10, wherein the indication comprises at least one of: (a) a visual indicator; (b) an audible indicator; (c) a vibration indicator; (d) a mechanical indicator; or (e) a message transmission indicator.

17. The sensor-based system of claim 10, wherein the output comprising the indication is detected by the one or more processors, and wherein the one or more processors prevent feedback to the user.

18. The sensor-based system of claim 10, wherein the computer readable medium comprises an onboard memory stored on the shaving device, and wherein each of the predetermined duration threshold value and the predetermined shave event threshold value is stored in the onboard memory.

19. A tangible, non-transitory computer-readable medium storing computing instructions for analyzing shaving usage based on time duration and shave event status, that when executed by one or more processors cause the one or more processors to:
define, in a computer readable memory, each of a predetermined duration threshold value and a predetermined shave event threshold value;
collect, by one or more processors, sensor data from a sensor of a shaving device having a blade, the sensor data collected while a user is shaving;
determine, based on the sensor data, user-specific pressure data defining one or more shaving strokes based on pressure applied to the user's skin;
detect, based on the one or more shaving strokes, that a shaving event occurred;
increment, in the computer readable memory and based on detection of the shaving event, a shave event count value;
determine that the shave event count value meets or exceeds the predetermined shave event threshold value;
track, based on a timer, one or more intervals of time values for each of the one or more shaving strokes;
calculate, based on the one or more interval of time values, a total duration of the one or more shaving strokes;
determine that the total duration meets or exceeds the predetermined duration threshold value, and;
generate an output associated with the shaving device based on (a) the determining that the total duration meets or exceeds the predetermined duration threshold value, and (b) the determining that the shave event count value meets or exceeds the predetermined shave event threshold value, the output comprising an indication that each of the predetermined duration threshold value and the predetermined shave event threshold value has been met or exceeded.

20. The tangible, non-transitory computer-readable medium of claim 19, wherein the computing instructions are further configured, when executed by the one or more processors, to:
define, in the computer readable memory, a second predetermined duration threshold value and a second predetermined shave event threshold value;
determine that the total duration meets or exceeds the second predetermined duration threshold value;
determine that the shave event count meets or exceeds the second predetermined shave event threshold value; and
generate a second output associated with the shaving device, the second output comprising a second indication that each of the second predetermined duration threshold value and the second predetermined shave event threshold value has been met or exceeded.
